(19) United States
(12) Patent Application Publication
(10) Pub. No.: US 2026/0070169 A1
(43) Pub. Date: Mar. 12, 2026

(54) BOLT FASTENING DEVICE MODULE AND METHOD FOR CONTROLLING SAME

(71) Applicant: SK On Co., Ltd., Seoul (KR)

(72) Inventors: Min Jeong HONG, Daejeon (KR); Yoong Hee LEE, Daejeon (KR); Jae Hun KIM, Daejeon (KR); Yoon Sung OH, Daejeon (KR); Seul Gi LEE, Daejeon (KR); Seung Won LEE, Daejeon (KR)

(21) Appl. No.: 19/238,529

(22) Filed: Jun. 16, 2025

(30) Foreign Application Priority Data
Sep. 9, 2024 (KR) 10-2024-0122670

(51) Int. Cl. B23P 19/06; B25J 9/16

(52) U.S. Cl. CPC B23P 19/06; B25J 9/1687

(57) ABSTRACT

Proposed is a bolt fastening device module, including a nutrunner having an end to which a is coupled, at least one sensing device coupled to the nutrunner, at least one coupling member having a fastening hole to which the bolt is coupled, and a controller coupled to the nutrunner and controlling the at least one sensing device to sense a height of at least one point on a circumferential surface of the fastening hole to adjust a coupling position of the bolt and the fastening hole.

### CROSS REFERENCE TO RELATED APPLICATION

The present application claims priority to Korean Patent Application No. 10-2024-0122670, filed Sep. 9, 2024, the entire contents of which is incorporated herein for all purposes by this reference.

### BACKGROUND OF THE INVENTION

### Field of the Invention

The present disclosure relates to a bolt fastening device module and a method for controlling the same.

### Description of the Related Art

Fastening of materials using bolts and related joining components has been widely used in various technical fields. In general, bolts are used to fix or join materials together. For this purpose, bolts and fastening holes for bolt fastening are provided in the materials.

In the secondary battery field, the process of assembling a module or a battery pack is one of the important processes for responding to vibrations or shocks applied to the module or pack itself. Since most materials that make up a secondary battery module or pack are made of low-rigidity materials such as aluminum plates or plastic, it is required to minimize physical deformation of these materials.

Additionally, when multiple materials are stacked and joined together, the center point of bolt fastening and the center point of the fastening hole may not coincide with each other due to accumulated tolerance. This causes distortion in the flexible material, resulting in various problems in the production process.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2004-0002058

### SUMMARY OF THE INVENTION

Accordingly, the present disclosure has been made keeping in mind the above problems occurring in the related art, and one objective of the present disclosure is to provide a bolt fastening device module that senses and corrects an exact position between a nutrunner for bolt fastening and a bolt fastening hole, thereby increasing reliability of bolt fastening while ensuring reliability and precision in bolt fastening automation.

In order to achieve the above objective, according to one aspect of the present disclosure, there is provided a bolt fastening device module, including: a nutrunner having an end to which a bolt is coupled; at least one sensing device coupled to the nutrunner; at least one coupling member having a fastening hole to which the bolt is coupled; and a controller coupled to the nutrunner and controlling the at least one sensing device to sense a height of at least one point on a circumferential surface of the fastening hole to adjust a coupling position of the bolt and the fastening hole.

Here, the at least one sensing device may include a plurality of sensing devices, and the plurality of sensing devices may be arranged at predetermined intervals along an outer peripheral surface of the nutrunner and coupled to positions corresponding to a shape of the above fastening hole.

Additionally, the circumferential surface of the fastening hole may be defined as a tapered surface that is inclined at a predetermined angle in an outer radial direction from a circumferential line of the fastening hole.

Additionally, the plurality of sensing devices may be configured as laser sensors, and the controller may control the plurality of sensing devices to measure heights of a plurality of points on a surface of the coupling member where the fastening hole is formed, and when the height values of the plurality of points all match a reference point corresponding to a height of a circumferential line where the fastening hole begins, operate the nutrunner to be moved toward the fastening hole.

Additionally, the controller may set a height of a circumferential line where the fastening hole begins to a reference point Z=0, set a height of a surface of the coupling member to a relative height difference Z=h from the reference point, and operate the nutrunner to be moved toward the fastening hole when a plurality of sensing values of the plurality of sensing devices all converge to Z=0.

According to another aspect of the present disclosure, there is provided a bolt fastening device module, including: a nutrunner having an end to which a bolt is coupled; a single sensing device coupled to the nutrunner; at least one coupling member having a fastening hole to which the bolt is coupled; and a controller coupled to the nutrunner and controlling the single sensing device to sense heights of a plurality of points on a circumferential surface of the fastening hole to adjust a coupling position of the bolt and the fastening hole.

Here, the single sensing device may sense the heights of the plurality of points while rotating along the nutrunner in a shape corresponding to a shape of the fastening hole.

Additionally, the circumferential surface of the fastening hole may be defined as a tapered surface that is inclined at a predetermined angle in an outer radial direction from a circumferential line where the fastening hole begins.

Additionally, the single sensing device may be configured as a laser sensor, and the controller may control the single sensing device to measure heights of a plurality of points on a surface of the coupling member where the fastening hole is formed, and when the height values of the plurality of points all match a height point of a circumferential line where the fastening hole begins, operate the nutrunner to be moved toward the fastening hole.

Additionally, the controller may set a height of a circumferential line where the fastening hole begins to a reference point Z=0, set a height of a surface of the coupling member is set to a relative height difference Z=h from the reference point, and operate the nutrunner to be moved toward the fastening hole when a plurality of sensing values of the single sensing device all converge to Z=0.

Additionally, the single sensing device may successively measure the heights of the plurality of points while rotating along the nutrunner in a shape corresponding to a shape of the fastening hole.

According to another aspect of the present disclosure, there is provided a method for controlling a bolt fastening device module, the method including: measuring heights of a plurality of sensing points on a surface of a coupling member to sense a position of a fastening hole; measuring height differences of the plurality of sensing points; determining whether a height difference of at least one point among the height differences of the plurality of sensing points exceeds a threshold value; sensing a position of an additional coupling member above the fastening hole based on a position where the height difference of the at least one point exceeds the threshold value and the measured height difference when the height difference of the at least one point among the height differences of the plurality of sensing points exceeds the threshold value; sensing an obstruction position of the fastening hole based on the position value of the additional coupling member; determining the obstruction position of the fastening hole and correcting a position of a nutrunner so that the heights of the plurality of sensing points all match a reference height of a circumferential line of the fastening hole; and lowering the nutrunner to fasten the bolt when the heights of the plurality of sensing points match the reference height of the circumferential line of the fastening hole.

Here, the plurality of sensing points may include a plurality of points arranged along a trajectory corresponding to a shape of the circumferential line of the fastening hole.

Additionally, the method may further include: correcting the position of the nutrunner so that the heights of the plurality of sensing points all match the reference height of the circumferential line of the fastening hole when the height difference of the at least one point among the height differences of the plurality of sensing points does not exceed the threshold value; and lowering the nutrunner toward the fastening hole to fasten the bolt when the heights of the plurality of sensing points all match the reference height of the circumferential line of the fastening hole.

Additionally, the correcting of the position of the nutrunner so that the heights of the plurality of sensing points all match the reference height of the circumferential line of the fastening hole may include: correcting the position in one direction in which a height of the at least one point among the plurality of sensing points gradually decreases or increases toward the circumferential line of the fastening hole by forming a tapered surface inclined from the circumferential line of the fastening hole toward the surface of the coupling member.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present disclosure, by forming a circumferential surface of a fastening hole to extend in the outward radial direction from the fastening hole to have a relative height difference, a sensing device included in a nutrunner to effectively can sense and correct the position of the fastening hole.

Additionally, by applying a plurality of sensing devices to the nutrunner and setting in advance position information on a plurality of reference points corresponding to various types of fastening holes, it is possible to improve precision of sensing the position of the fastening hole.

Additionally, by forming the circumferential surface having a relative height difference along a circumferential line including the starting point of the fastening hole, the sensing devices can more accurately recognize the position of the fastening hole when performing sensing along the circumferential surface.

Additionally, when a single sensing device is used, this sensing device can sense height differences of a plurality of preset points while rotating within a preset trajectory range along the circumferential line corresponding to the shape of the fastening hole, thereby determining the position of the fastening hole based on the corresponding information and precisely correcting the position of the nutrunner.

Additionally, even when the single sensing device is used, the sensing device can sense height differences of consecutive location points while rotating within the preset trajectory range, thereby further improving precision of sensing the position of the fastening hole.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a bolt fastening device module according to an embodiment of the present disclosure;

FIG. 2 is a sensing schematic view illustrating a case where the bolt fastening device module according to the embodiment of the present disclosure is in a correct position;

FIG. 3 is a sensing schematic view illustrating a case where correction for the bolt fastening device module according to the embodiment of the present disclosure is required;

FIG. 4 is a sensing schematic view illustrating a case where correction for the bolt fastening device module according to the embodiment of the present disclosure is required;

FIG. 5 is a perspective view illustrating a bolt fastening device module according to another embodiment of the present disclosure;

FIG. 6 is a sensing schematic view illustrating a case where a sensing device of the bolt fastening device module according to the other embodiment of the present disclosure is in a correct position;

FIG. 7 is a sensing schematic view illustrating a case where correction for the bolt fastening device module according to the other embodiment of the present disclosure is required;

FIG. 8 is a sensing schematic view illustrating a bolt fastening device module according to a modified example of the other embodiment of the present disclosure; and

FIG. 9 is a flowchart illustrating a method for controlling a bolt fastening device module according to an embodiment of the present disclosure.

### DETAILED DESCRIPTION OF THE INVENTION

Terms used in this specification are selected to describe embodiments and thus should not be construed as the limit of the present disclosure. As used herein, the singular forms are intended to include the plural forms as well, unless the context clearly indicates otherwise.

As for reference numerals associated with parts in the drawings, the same or similar reference numerals will refer to the same or similar parts throughout different drawings.

Note that the drawings may be schematic or exaggerated for convenience of explanation. The terms “have”, “may have”, “include”, and “may include” as used herein indicate the presence of corresponding features (for example, elements such as numerical values, functions, operations, or parts), and do not preclude the presence of additional features.

Although the terms “one”, “other”, “another”, “first”, “second”, etc. may be used only to distinguish one element from another element, these elements should not be limited by these terms.

Hereinbelow, exemplary embodiments of the present disclosure will be described in detail with reference to the accompanying drawings.

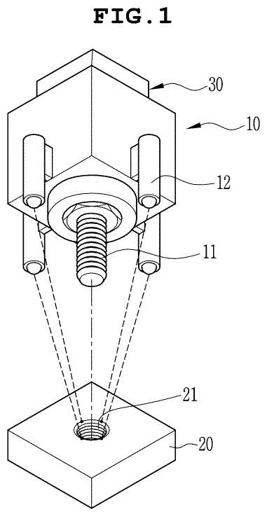

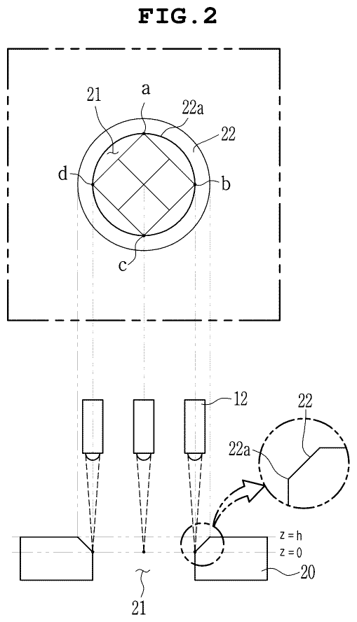

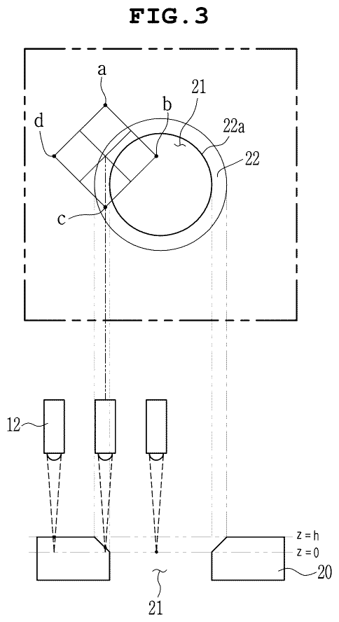

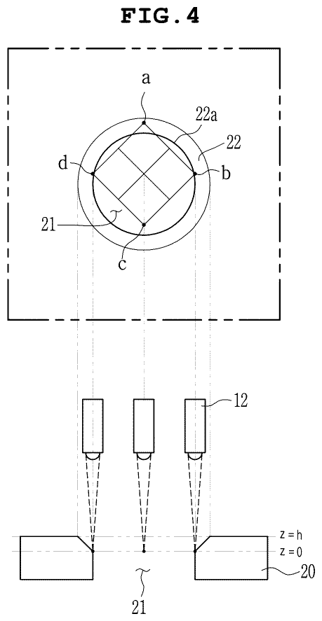

FIG. 1 is a perspective view illustrating a bolt fastening device module according to an embodiment of the present disclosure. FIG. 2 is a sensing schematic view illustrating a case where the bolt fastening device module according to the embodiment of the present disclosure is in a correct position. FIG. 3 is a sensing schematic view illustrating a case where correction for the bolt fastening device module according to the embodiment of the present disclosure is required. FIG. 4 is a sensing schematic view illustrating a case where correction for the bolt fastening device module according to the embodiment of the present disclosure is required.

A bolt fastening device module according to an embodiment of the present disclosure may include a nutrunner 10 having an end to which a bolt 11 is coupled, at least one sensing device 12 coupled to the nutrunner 10, at least one coupling member 20 having a fastening hole 21 to which the bolt 11 is coupled, and a controller 30 coupled to the nutrunner 10 and controlling the at least one sensing device 12 to sense a height of at least one point on a circumferential surface 22 of the fastening hole 21 to adjust a coupling position of the bolt 11 and the fastening hole 21.

As illustrated in FIG. 1, the nutrunner 10 is a configuration for fastening the bolt 11. The nutrunner 10 may have the end to which the bolt 11 is coupled, and may fasten the bolt 11 to the fastening hole 21 by moving the end toward the coupling member 20 and rotating the bolt 11.

At least one sensing device 12 may be arranged along an outer peripheral surface of the nutrunner 10, or a plurality of sensing devices 12 may be arranged at predetermined intervals to sense positions corresponding to the shape of the fastening hole 21. Depending on the shape or size of the fastening hole 21, the sensing device 12 may be applied in an appropriate number to effectively sense an exact position of the fastening hole 21.

With this configuration, the nutrunner 10 may be accurately moved vertically toward the fastening hole 21 based on sensed information, and guide the bolt 11 to be precisely fastened to the fastening hole 21 of the coupling member 20.

The circumferential surface 22 of the fastening hole 21 may be defined as a tapered surface that is inclined at a predetermined angle in the outer radial direction from a circumferential line 22a where the fastening hole 21 begins.

At this time, the circumferential surface 22 of the fastening hole 21 may be inclined over a predetermined range to increase precision of position sensing, thereby forming a relative height difference at each point in the direction of the fastening hole 21. By utilizing this relative height difference, the sensing device 12 may detect a position of the fastening hole 21 more effectively. Furthermore, there is an advantage in that position correction may be performed more accurately in the direction of the fastening hole 21 from a position around the fastening hole 21.

The controller 30 may be coupled to the nutrunner 10. However, the controller 30 is not limited to the configuration illustrated in the drawings, and may be configured integrally with the nutrunner 10 through a separate wired or wireless connection or may be disposed spaced apart from the nutrunner 10.

The controller 30 may vertically align the nutrunner 10 with respect to the fastening hole 21 and accurately position the nutrunner 10 in the fastening direction, based on height values with respect to a surface of the coupling member 20 sensed by a plurality of sensing devices 12.

The sensing device 12 may be provided in plural, and the plurality of sensing devices 12 may be configured as laser sensors. In this case, the controller 30 may control the plurality of sensing devices 12 to measure heights of a plurality of points around the fastening hole 21 of the coupling member 20 at the current position of the nutrunner 10. When the height values of the plurality of points sensed by the plurality of sensing devices 12 all match a reference height of the circumferential line 22a where the fastening hole 21 begins, the controller 30 may operate the nutrunner 10 to be moved toward the fastening hole 21 to accurately fasten the bolt 11 to the fastening hole 21.

Here, the plurality of sensing devices 12 may be set in advance according to positions corresponding to the shape of the fastening hole 21, and the position of the fastening hole 21 may be sensed based on the set values.

By setting in advance a plurality of points that match the shape of the fastening hole 21, the plurality of sensing devices 12 may more effectively detect positions that exactly match the fastening hole 21. Additionally, depending on the size or shape of the fastening hole 21, one sensing device 12 may be applied in a manner that senses a specific single point.

Specifically, the plurality of sensing devices 12 may be set so that a plurality of sensing points are arranged along the circumferential line 22a, which is the starting point of the fastening hole 21. Accordingly, when the plurality of sensing points all correspond to the circumferential line 22a of the fastening hole 21, it may be determined that the bolt 11 and the fastening hole 21 are aligned on the same vertical line.

At this time, the height of the circumferential line 22a where the fastening hole 21 begins may be set as a reference point, and this reference height may be defined as Z=0. The height mentioned here may refer to a distance between the sensing devices 12 and the coupling member 20.

Additionally, the circumferential surface 22 that starts from the circumferential line 22a of the fastening hole 21 and forms a surface of a predetermined range may be defined as a tapered surface that is inclined to have a relative height difference. Due to the inclination of the circumferential surface 22, the direction of the fastening hole 21 may be sensed based on the relative height difference.

That is, when the height value of the surface of the coupling member 20 is set to a relative difference Z=h from the reference point and the values sensed at the plurality of points of the plurality of sensing devices 12 all match the height (Z=0) of the reference position, the controller 30 may operate the nutrunner 10 to be moved toward the fastening hole 21 to accurately fasten the bolt 11 to the fastening hole 21.

When the sensing devices 12 perform sensing in an internal space of the fastening hole 21, the relative height value cannot be measured at the corresponding position. Therefore, the controller 30 may recognize this as an error signal or process it as a predetermined specific value and determines that the corresponding position is the internal space of the fastening hole 21, thereby detecting a fastening position more effectively.

Additionally, even when one sensing device 12 is used, the differences of the sensed points in the height values in the forward, backward, left, and right directions may be analyzed, thereby improving precision of sensing the position of the fastening hole 21. In other words, taking into account its position coupled to the outer peripheral surface of the nutrunner 10, the sensing device 12 may accurately position the nutrunner 10 with respect to the internal space of the fastening hole 21 using the height differences in the forward, backward, left, and right directions so that the nutrunner 10 is aligned with the internal space of the fastening hole 21.

As illustrated in FIG. 2, the sensing points of the initial plurality of sensing devices 12 may be set to four points, a, b, c, and d, located on the circumferential line 22a of the fastening hole 21. The four points may be set at positions that match the shape and size of the fastening hole 21. Then, when the plurality of sensing devices 12 measure the heights with respect to the surface of the coupling member 20 and the height values of all the four points match the reference height of the circumferential line 22a of the fastening hole 21, it may be determined that the nutrunner 10 is accurately positioned in a correct position.

As illustrated in FIG. 3, this shows a case in which the measurement points of the plurality of sensing devices 12 are sensed to be outside the fastening hole 21. At this time, the height values of the point b, which senses the internal space of the fastening hole 21, the point c, which senses any one position on the circumferential surface 22 of the fastening hole 21, and the points a and d, which sense the surface of the coupling member 20, may be determined. By using the difference between each height value and the reference height, the nutrunner 10 may be moved through the controller 30 so that each height value matches the height value Z=0, i.e., the reference point, of the circumferential line 22a of the fastening hole 21.

The controller 30 may correct the position of the nutrunner 10 by moving the nutrunner 10 toward the correct position of the fastening hole 21 and induce accurate operation by comparing the preset initial shape and size of the fastening hole 21 with each point value set in the sensing devices 12.

It may also be configured such that a specific method of this correction logic can adopt various known methods and thus it includes all known methods and is not limited to a specific logic.

As illustrated in FIG. 4, there may be a case where the plurality of sensing devices 12 sense the circumferential surface 22 of the fastening hole 21 and the internal space of the fastening hole 21. In this case as well, the point a sensing the circumferential surface 22 of the fastening hole 21 may be moved in an inner direction, i.e., a height decreasing direction, of the circumferential surface 22, and the point c on the opposite side may also be naturally moved together to correspond to the circumferential line 22a of the fastening hole 21.

As such, when the height of the starting point of the circumferential line 22a where the fastening hole 21 begins is used as the reference point and movement is made in a direction closer to the reference point, i.e., in a direction in which the relative height difference from the reference height on the circumferential surface 22 decreases, the points of the plurality of adjacent sensing devices 12 may also be moved together so that the nutrunner 10 is naturally positioned in a direction aligned with the fastening hole 21.

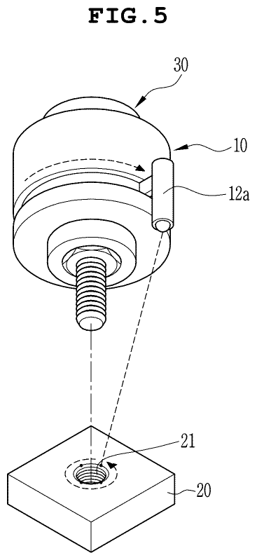

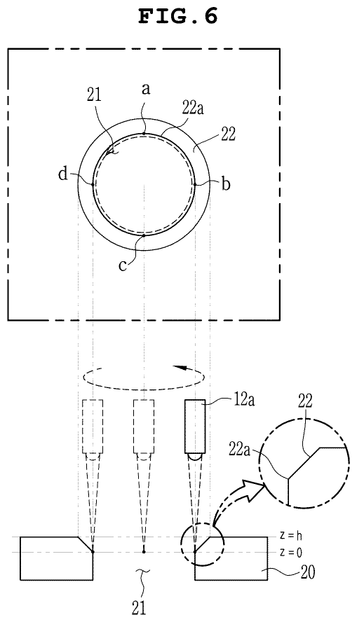

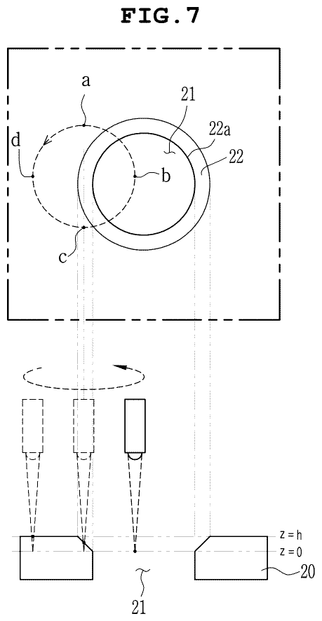

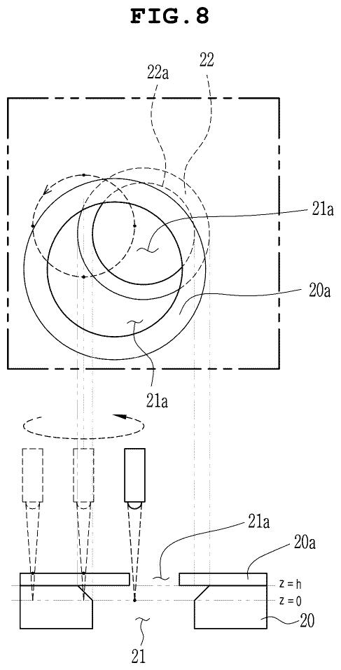

FIG. 5 is a perspective view illustrating a bolt fastening device module according to another embodiment of the present disclosure. FIG. 6 is a sensing schematic view illustrating a case where a sensing device 12a of the bolt fastening device module according to the other embodiment of the present disclosure is in a correct position. FIG. 7 is a sensing schematic view illustrating a case where correction for the bolt fastening device module according to the other embodiment of the present disclosure is required. FIG. 8 is a sensing schematic view illustrating a bolt fastening device module according to a modified example of the other embodiment of the present disclosure.

A bolt fastening device module according to another embodiment of the present disclosure may include a nutrunner 10 having an end to which a bolt 11 is coupled, a single sensing device 12a coupled to the nutrunner 10, at least one coupling member 20 having a fastening hole 21 to which the bolt 11 is coupled, and a controller 30 coupled to the nutrunner 10 and controlling the single sensing device 12a to sense heights of a plurality of points on a circumferential surface 22 of the fastening hole 21 to adjust a coupling position of the bolt 11 and the fastening hole 21.

The bolt fastening device module according to the other embodiment of the present disclosure is operated in such a manner that the fastening hole 21 is sensed through one sensing device 12a. That is, the single sensing device 12a may sense a height of each moving point while rotating in a shape corresponding to the shape of the fastening hole 21, and based on the height value of each point, sense a position of the fastening hole 21 and correct a position of the nutrunner 10, thereby aligning a fastening position with the fastening hole 21.

Hereinafter, description of configurations that overlap with those of the embodiment of the present disclosure described above will be omitted.

The nutrunner 10 and the single sensing device 12a coupled to the nutrunner 10 may be configured as illustrated in FIG. 5. It goes without saying that the direction of rotation of the single sensing device 12a, its rotating shape, or its position of coupling to the nutrunner 10 are not limited to those illustrated. The sensing device 12a is not limited to the configuration illustrated in the drawings as long as it has a position and shape that enables measurement of the heights with respect to a surface of the coupling member 20. However, it is appropriate to couple the sensing device 12a to sense a plurality of points set in advance according to shape and size of the fastening hole 21.

As illustrated in FIG. 5, the single sensing device 12a may be coupled to rotate along an outer peripheral surface of the nutrunner 10. The single sensing device 12a may sense the heights of a plurality of points on the surface of the coupling member 20 while rotating along the outer peripheral surface of the nutrunner 10 in a shape corresponding to the shape of the fastening hole 21.

That is, the trajectory along which the single sensing device 12a rotates may be set to correspond to the shape of the fastening hole 21, and the single sensing device 12a may sense the heights with respect to the surface of the coupling member 20 at continuous or discontinuous points while moving along the trajectory.

Similarly to the embodiment of the present disclosure already described above, the circumferential surface 22 of the fastening hole 21 of the coupling member 20 may be defined as a tapered surface that is inclined at a predetermined angle in the outer radial direction from a circumferential line 22a where the fastening hole 21 begins. It goes without saying that the tapered surface is not limited to the shape illustrated, and depending on the fastening position or shape of the coupling member 20, there may be applied various shapes, such as a tapered surface that gradually lowers from the circumferential line 22a of the fastening hole 21 or a shape that forms a relative height difference on the circumferential surface 22.

As illustrated in FIG. 6, the trajectory along which the single sensing device 12a rotates may be set to correspond to the shape and size of the fastening hole 21. Accordingly, when sensing the position of the fastening hole 21, the positions at a plurality of points may be matched and at the same time, the remaining points may also be moved together to guide the nutrunner 10 to a correct position in the fastening hole 21. FIG. 6 illustrates a state in which the single sensing device 12a senses the heights with respect to the surface of the coupling member 20 at a plurality of points corresponding to the circumferential line 22a where the fastening hole 21 begins while rotating. Although four points are illustrated in the drawings, it may also be configured such that the single rotating sensing device 12a successively senses the heights of a plurality of location points at finer intervals.

The single sensing device 12a may be configured as a laser sensor, and the controller 30 may control the single sensing device 12a to measure the heights of a plurality of points on the surface of the coupling member 20 where the fastening hole 21 is formed.

The controller 30 may control the single sensing device 12a to measure the heights of the plurality of points on the surface of the coupling member 20 where the fastening hole 21 is formed, and when the height values of the plurality of points all match a reference height point of the circumferential line 22a where the fastening hole 21 begins, operate the nutrunner 10 to be moved toward the fastening hole 21.

Specifically, as illustrated in FIG. 6, the height of the circumferential line 22a where the fastening hole 21 begins may be set as a reference point Z=0, and the height of the surface of the coupling member 20 may be set as a relative height difference Z=h from the reference point, so when a plurality of sensing values of the single sensing device 12a all satisfy Z=0, the nutrunner 10 may be operated to be moved toward the fastening hole 21 to accurately fasten the bolt 11 to the fastening hole 21.

With this height difference, it may also be configured such that the nutrunner 10 is operated in a direction in which the relative height difference gradually decreases from a sensing point of the single sensing device 12a and is aligned in position with the fastening hole 21.

As illustrated in FIG. 7, when the position of the nutrunner 10 does not satisfy the value Z=0 at all the four points on the trajectory of the single sensing device 12a, it may be determined that the nutrunner 10 is not located at a position aligned with the fastening hole 21.

In this case, the controller 30 may correct the position of the nutrunner 10 by moving the nutrunner 10 to a normal position through a point b sensing an internal space of the fastening hole 21 and a point d sensing the height Z=h of the surface of the coupling member 20. In detail, the point b may be moved in one direction until it reaches the reference height of the circumferential line 22a where the fastening hole 21 begins, and after reaching the circumferential line 22a of the fastening hole 21, the height differences of the remaining points may be sensed again to correct the overall position.

For example, the controller 30 may determine the points sensed on the circumferential surface 22 of the fastening hole 21, and correct the position of the nutrunner 10 by operating the nutrunner 10 to be moved toward the fastening hole 21 using the midpoint of two points that lie on the circumferential line 22a.

It may also be configured such that various calculation methods and correction logics including known methods can be applied to find the center of the fastening hole 21 and operate the nutrunner 10 by using the height value at each point measured along the trajectory direction of the single sensing device 12a.

The single sensing device 12a may successively measure the height of each point while rotating along the nutrunner 10 in a shape corresponding to the shape of the fastening hole 21. That is, by sensing the height differences of consecutive points within the rotation range of the single sensing device 12a, precision and reliability of position correction for the nutrunner 10 may be secured.

FIG. 8 illustrates a case where a fastening hole 21 is obstructed when another additional coupling member 20a is provided on top of a general single coupling member 20. In this case as well, the controller 30 may confirm the existence of the additional coupling member 20a based on the height values in the range exceeding the value Z=h for a surface of the initial coupling member 20, and determine the position of a fastening hole 21a based on the height values sensed by the additional coupling member 20a.

Additionally, in the structure formed by overlapping the additional coupling member 20a and the existing coupling member 20, this height difference may be used to sense the position of the fastening hole 21 where fastening is possible or to sense whether the fastening hole 21 is in a state where fastening is impossible due to overlapping of the two coupling members, thereby further securing work reliability.

If the system is initially designed with an additional coupling member 20a, by setting in advance information on the height of a surface of the additional coupling member 20a and the position of the fastening hole 21a, the controller 30 may control the nutrunner 10 to accurately fasten the bolt 11 to fastening holes 21a of a plurality of overlapping coupling members 20a.

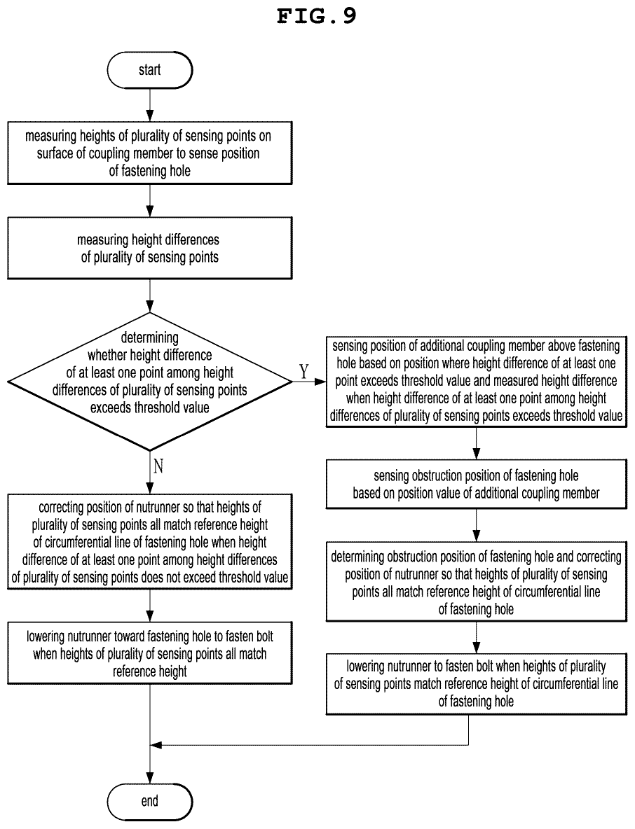

FIG. 9 is a flowchart illustrating a method for controlling a bolt fastening device module according to an embodiment of the present disclosure.

As illustrated in FIG. 9, a method for controlling a bolt fastening device module according to an embodiment of the present disclosure may include: measuring heights of a plurality of sensing points on a surface of a coupling member to sense a position of a fastening hole; measuring height differences of the plurality of sensing points; determining whether a height difference of at least one point among the height differences of the plurality of sensing points exceeds a threshold value; sensing a position of an additional coupling member above the fastening hole based on a position where the height difference of the at least one point exceeds the threshold value and the measured height difference when the height difference of the at least one point among the height differences of the plurality of sensing points exceeds the threshold value; sensing an obstruction position of the fastening hole based on the position value of the additional coupling member; determining the obstruction position of the fastening hole and correcting a position of a nutrunner so that the heights of the plurality of sensing points all match a reference height of a circumferential line of the fastening hole; and lowering the nutrunner to fasten the bolt when the heights of the plurality of sensing points match the reference height of the circumferential line of the fastening hole.

First, the heights of the plurality of sensing points on the surface of the coupling member are measured to sense the position of the fastening hole of the coupling member. The coupling member is a member to which a bolt is to be fastened, and is a member in which a fastening hole to which the bolt is fastened is formed. The plurality of points may be sensed at a plurality of locations on the trajectory corresponding to the shape of the fastening hole or along the trajectory.

Next, the height differences of the plurality of sensing points are measured.

In the bolt fastening device module according to the embodiment of the present disclosure described above, as illustrated in FIG. 3 or FIG. 7, the height of each of the plurality of sensing points may be measured to find a position that corresponds to a circumferential line, i.e., an outer circumference, of the fastening hole, thereby determining a correct position of the fastening hole.

Specifically, as illustrated in FIG. 3, the point of the circumferential line of the fastening hole may be set to Z=0 and a tapered surface that extends from the circumferential line in the outward radial direction may be formed. Accordingly, the sensing points may be moved in a direction in which the height of each of the plurality of sensing points converges to Z=0, i.e., in a direction in which the measured height gradually increases or decreases according to the shape of the tapered surface, thereby exactly aligning the position of the fastening hole with a bolt fastening position.

Next, whether the height difference of the at least one point among the height differences of the plurality of sensing points exceeds the threshold value is determined.

In the present disclosure, by forming the fastening hole in the coupling member and forming the tapered surface extending from the circumferential line of the fastening hole, the position of the fastening hole may be sensed more effectively by utilizing the relative height difference. As illustrated in FIG. 3, the maximum and minimum values of the height difference of the tapered surface formed along the outer circumference of the fastening hole formed in one coupling member may be set to Z=h and Z=0, respectively. When the maximum value of the height difference is exceeded, it may be determined as a situation where a preset threshold value is exceeded, and it may be determined whether the fastening hole is obstructed by a separate additional coupling member on top of the existing coupling member and the sensing of the fastening hole is hindered (see FIG. 8).

When the height difference of the at least one point among the height differences of the plurality of sensing points exceeds the threshold value, the position of the additional coupling member above the fastening hole may be sensed based on the corresponding position and its measurement value. The position of the additional coupling member may be determined by measuring a thickness of the additional coupling member based on the difference between the maximum height value set by default and the height value exceeding the threshold value.

Next, the obstruction position of the fastening hole is sensed based on the position value of the additional coupling member. After sensing the position of the additional coupling member, a sensing device may perform position correction so that the height differences of the sensing points are adjusted to within the range of the preset height difference.

Next, the obstruction position of the fastening hole is determined and the position of the nutrunner is corrected so that the heights of the plurality of sensing points all match the reference height of the circumferential line of the fastening hole. In this case, when the obstruction position of the fastening hole is determined and it is determined that two or more sensing points among the plurality of sensing points match the reference height of the circumferential line of the fastening hole, it may be determined that the fastening hole for bolt fastening is in the correct position. On the other hand, when a part of the fastening hole is obstructed, the reference height of the circumferential line of the fastening hole may not be satisfied at all the sensing points. However, in this case, whether the fastening hole is in the correct position or whether to operate the nutrunner to actually fasten the bolt may be determined separately. The related contents will be described in detail in the following step.

Next, when the heights of the plurality of sensing points match the reference height of the circumferential line of the fastening hole, the nutrunner is lowered to fasten the bolt.

When the fastening hole is physically obstructed by the additional coupling member, a part of the plurality of sensing points may not match the reference height due to the obstruction phenomenon. However, when the remaining sensing points match the reference height, it may be determined that the fastening hole is in the correct position for bolt fastening.

An opening ratio of the fastening hole may be determined based on the obstruction position of the fastening hole, and it may be determined whether the obstruction by the additional coupling member is physically and naturally eliminated when the nutrunner is operated to be moved toward the fastening hole. In this case, the nutrunner may be physically lowered and fasten the bolt to the correct position in the fastening hole despite the fastening hole being obstructed.

When the opening ratio of the fastening hole is not sufficient for the nutrunner to fasten the bolt due to the obstruction position of the fastening hole, the additional coupling member may be physically moved, or the current bolt fastening operation may be temporarily stopped or terminated.

In the method for controlling the bolt fastening device module according to the embodiment of the present disclosure, the plurality of sensing points may include a plurality of points arranged along a trajectory corresponding to the shape of the circumferential line of the fastening hole.

That is, by appropriately setting the shape and positional relationship of the plurality of sensing points in advance in consideration of the size or shape of the fastening hole of the coupling member to be bolted, the position of the fastening hole may be sensed more effectively.

For one sensing device, it may successively or intermittently sense a plurality of points while moving within the range of the corresponding trajectory. Alternatively, it may also be configured such that a plurality of sensing devices are arranged at a plurality of positions to sense a plurality of sensing points.

When the height difference of the at least one point among the height differences of the plurality of sensing points does not exceed the threshold value, the position of the nutrunner may be corrected so that the heights of the plurality of sensing points all match the reference height of the circumferential line of the fastening hole, and when the heights of the plurality of sensing points all match the reference height, the nutrunner may be lowered toward the fastening hole to fasten the bolt.

In this case, by utilizing the relative height difference of the tapered surface extending in the outward direction from the circumferential line of the fastening hole, the position of the fastening hole may be accurately sensed and the position of the nutrunner may be precisely corrected to the corresponding position.

When the plurality of sensing points match the reference height Z=0 of the circumferential line of the fastening hole, the nutrunner may be lowered to fasten the bolt to the fastening hole.

Here, the correcting of the position of the nutrunner so that the heights of the plurality of sensing points all match the reference height of the circumferential line of the fastening hole may include: correcting the position in one direction in which the height of the at least one point among the plurality of sensing points gradually decreases or increases toward the circumferential line of the fastening hole by forming the tapered surface inclined from the circumferential line of the fastening hole toward the surface of the coupling member.

The tapered surface may be an inclined surface that is inclined upward or downward in the outward direction from the circumferential line of the fastening hole. Due to this relative height difference of the tapered surface, the nutrunner may be controlled to approach the fastening hole in a direction in which the height value Z gradually decreases or increases toward the fastening hole.

Additionally, the method for controlling the bolt fastening device module according to the embodiment of the present disclosure is not limited to the configuration of the bolt fastening device module according to the embodiment of the present disclosure already described above, and it goes without saying that various physical configurations that perform the control method of the present disclosure are possible.

The present disclosure has been described in detail through specific embodiments thereof. The embodiments of the present disclosure are disclosed only for illustrative purposes and should not be construed as limiting the present disclosure. It will be understood by those of ordinary skill in the art that various changes and modifications may be made therein without departing from the technical idea and scope of the present disclosure and such changes and modifications belong to the claims of the present disclosure.

What is claimed is:

1. A bolt fastening device module, comprising:
a nutrunner having an end to which a bolt is coupled;
at least one sensing device coupled to the nutrunner;
at least one coupling member having a fastening hole to which the bolt is coupled; and
a controller coupled to the nutrunner and controlling the at least one sensing device to sense a height of at least one point on a circumferential surface of the fastening hole to adjust a coupling position of the bolt and the fastening hole.

2. The bolt fastening device module of claim 1, wherein the at least one sensing device comprises a plurality of sensing devices, and the plurality of sensing devices are arranged at predetermined intervals along an outer peripheral surface of the nutrunner and coupled to positions corresponding to a shape of the fastening hole.

3. The bolt fastening device module of claim 1, wherein the circumferential surface of the fastening hole is defined as a tapered surface that is inclined at a predetermined angle in an outer radial direction from a circumferential line of the fastening hole.

4. The bolt fastening device module of claim 2, wherein the plurality of sensing devices are configured as laser sensors, and the controller controls the plurality of sensing devices to measure heights of a plurality of points on a surface of the coupling member where the fastening hole is formed, and when the height values of the plurality of points all match a reference point corresponding to a height of a circumferential line where the fastening hole begins, operates the nutrunner to be moved toward the fastening hole.

5. The bolt fastening device module of claim 2, wherein the controller sets a height of a circumferential line where the fastening hole begins to a reference point Z=0,
sets a height of a surface of the coupling member to a relative height difference Z=h from the reference point, and
operates the nutrunner to be moved toward the fastening hole when a plurality of sensing values of the plurality of sensing devices all converge to Z=0.

6. A bolt fastening device module, comprising:
a nutrunner having an end to which a bolt is coupled;
a single sensing device coupled to the nutrunner;
at least one coupling member having a fastening hole to which the bolt is coupled; and
a controller coupled to the nutrunner and controlling the single sensing device to sense heights of a plurality of points on a circumferential surface of the fastening hole to adjust a coupling position of the bolt and the fastening hole.

7. The bolt fastening device module of claim 6, wherein the single sensing device senses the heights of the plurality of points while rotating along the nutrunner in a shape corresponding to a shape of the fastening hole.

8. The bolt fastening device module of claim 7, wherein the circumferential surface of the fastening hole is defined as a tapered surface that is inclined at a predetermined angle in an outer radial direction from a circumferential line where the fastening hole begins.

9. The bolt fastening device module of claim 6, wherein the single sensing device is configured as a laser sensor, and the controller controls the single sensing device to measure heights of a plurality of points on a surface of the coupling member where the fastening hole is formed, and when the height values of the plurality of points all match a height point of a circumferential line where the fastening hole begins, operates the nutrunner to be moved toward the fastening hole.

10. The bolt fastening device module of claim 6, wherein the controller sets a height of a circumferential line where the fastening hole begins to a reference point Z=0,
sets a height of a surface of the coupling member is set to a relative height difference Z=h from the reference point, and
operates the nutrunner to be moved toward the fastening hole when a plurality of sensing values of the single sensing device all converge to Z=0.

11. The bolt fastening device module of claim 6, wherein the single sensing device successively measures the heights of the plurality of points while rotating along the nutrunner in a shape corresponding to a shape of the fastening hole.

12. A method for controlling a bolt fastening device module, the method comprising:
measuring heights of a plurality of sensing points on a surface of a coupling member to sense a position of a fastening hole;
measuring height differences of the plurality of sensing points;
determining whether a height difference of at least one point among the height differences of the plurality of sensing points exceeds a threshold value;
sensing a position of an additional coupling member above the fastening hole based on a position where the height difference of the at least one point exceeds the threshold value and the measured height difference when the height difference of the at least one point among the height differences of the plurality of sensing points exceeds the threshold value;
sensing an obstruction position of the fastening hole based on the position value of the additional coupling member;
determining the obstruction position of the fastening hole and correcting a position of a nutrunner so that the heights of the plurality of sensing points all match a reference height of a circumferential line of the fastening hole; and
lowering the nutrunner to fasten the bolt when the heights of the plurality of sensing points match the reference height of the circumferential line of the fastening hole.

13. The method of claim 12, wherein the plurality of sensing points include a plurality of points arranged along a trajectory corresponding to a shape of the circumferential line of the fastening hole.

14. The method of claim 12, further comprising:
correcting the position of the nutrunner so that the heights of the plurality of sensing points all match the reference height of the circumferential line of the fastening hole when the height difference of the at least one point among the height differences of the plurality of sensing points does not exceed the threshold value; and
lowering the nutrunner toward the fastening hole to fasten the bolt when the heights of the plurality of sensing points all match the reference height of the circumferential line of the fastening hole.

15. The method of claim 14, wherein the correcting of the position of the nutrunner so that the heights of the plurality of sensing points all match the reference height of the circumferential line of the fastening hole comprises:
correcting the position in one direction in which a height of the at least one point among the plurality of sensing points gradually decreases or increases toward the circumferential line of the fastening hole by forming a tapered surface inclined from the circumferential line of the fastening hole toward the surface of the coupling member.
